(19) United States
(12) Patent Application Publication
(10) Pub. No.: US 2013/0330640 A1
(43) Pub. Date: Dec. 12, 2013

(54) METAL SUPPORTED NANOWIRE CATHODE CATALYSTS FOR LI-AIR BATTERIES

(71) Applicants: Michael Edward Badding, Campbell, NY (US); Yanming Cui, Shanghai (CN); Lin He, Horseheads, NY (US); Zhaoyin Wen, Shanghai (CN); Xiangwei Wu Wu, Shanghai (CN)

(72) Inventors: Michael Edward Badding, Campbell, NY (US); Yanming Cui, Shanghai (CN); Lin He, Horseheads, NY (US); Zhaoyin Wen, Shanghai (CN); Xiangwei Wu Wu, Shanghai (CN)

(21) Appl. No.: 13/842,247

(22) Filed: Mar. 15, 2013

Related U.S. Application Data
(60) Provisional application No. 61/658,557, filed on Jun. 12, 2012.

(51) Int. Cl. H01M 4/90

(52) U.S. Cl. CPC H01M 4/9016
USPC 429/405; 204/471; 205/57; 427/126.3; 427/458

(57) ABSTRACT

A cathode current collector includes a porous metallic or conductive ceramic support and an oxide catalyst in the form of nanowires formed over the support. The nanowire catalyst may be oriented substantially perpendicular to surfaces of the substrate. An example oxide catalyst is cobalt oxide, and an example substrate is nickel foam.

### CROSS-REFERENCE TO RELATED APPLICATIONS

This application claims the benefit of priority under 35 U.S.C. §119 of U.S. Provisional Application Ser. No. 61/658,557 filed on Jun. 12, 2012, the content of which is relied upon and incorporated herein by reference in its entirety.

### BACKGROUND

The present disclosure relates generally to lithium-air batteries, and more particularly to electrode designs for use in such batteries.

A lithium-air battery includes a metal-air battery chemistry that uses the oxidation of lithium at the anode and reduction of oxygen at the cathode to induce a current flow. Lithium-air batteries have been the subject of recent research due to the high energy density that they can store. The improvement in the energy density over conventional batteries is primarily achieved by using atmospheric oxygen as a source of fuel rather than storing an oxidizer internally.

Lithium metal is a conventional choice for the anode material in Li-air batteries. At the anode, lithium oxidizes under an electrochemical potential and gives off an electron according to the half-cell reaction Li [symbol] Li⁺+e⁻. Conversely, at the cathode reduction occurs by the recombination of lithium ions with oxygen. Mesoporous carbon materials are conventionally used for the cathode material, i.e., cathode current collector. In cells using aprotic electrolytes, reduction at the cathode can be described by the half-cell reaction Li⁺+e⁻+O₂ [symbol] Li₂O₂.

A challenge to the successful implementation of non-aqueous carbon cathode-based Li-air batteries is the insolubility of the lithium oxide reaction products. For instance, lithium peroxide, Li₂O₂, may be observed as the reaction product in non-aqueous Li-air batteries. Accumulation of lithium reaction products creates a mass diffusion barrier in the cathode structure which can eventually inhibit the reaction kinetics of the battery.

A further obstacle to cathode-based Li-air batteries is the large polarization encountered during cycling. This large cell polarization may be due to the high activation energy required to produce Li₂O₂ during discharging and to decompose the Li₂O₂ reaction product during charging.

Metal catalysts can be incorporated into the carbon electrode to enhance the oxygen reduction kinetics and increase the specific capacity of the cathode. Specifically, the addition of catalytic materials can improve the discharge/charge efficiencies and affect the re-chargeability of the cells. However, only limited success has been achieved with respect to both insolubility and high polarization. Further, in conventional approaches where catalysts are incorporated into porous carbon cathodes by mechanical mixing, it is difficult to ensure both a uniform dispersion of the catalyst sites and sufficient contact between the catalyst material and the underlying support.

In view of the foregoing, an effectively catalyzed cathode for oxygen reduction and oxygen evolution reaction in Li-air batteries is highly desirable.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### SUMMARY

A cathode current collector for a lithium-air battery comprises a porous conductive support and nanoscale wires of a metal oxide catalyst formed over, and optionally in direct physical contact with the support. In embodiments, the nanoscale wires can have an average diameter in a range of 5 to 1000 nm, an average length in a range of 1 to 1000 microns, and an aspect ratio (length/diameter) of at least 5 (e.g., at least 10 or at least 20).

The nanoscale wires are termed a “catalyst” as they can reduce the charge and discharge over-potentials. In addition to their catalyst function, the wire-like geometry, which provides a relatively high surface area and is less prone to clogging compared to typical porous accumulator structures, may facilitate the accumulation of lithium oxide reaction product.

The nanoscale wires can be oriented with respect to the substrate such that, for example, they extend substantially orthogonal to a surface of the support, or extend from a surface of the support at an angle of from 30° to 90° (where 90° corresponds to orthogonal).

The porous substrate can comprise an elemental metal (e.g., Fe, Ni, Ti, Al or Cu), carbon, a compound of a transition metal element, a conductive ceramic, or alloys and composite mixtures of these materials. Also, the porous substrate can comprise stainless steel, steel wool, SiC or Si₃N₄. In embodiments, the porous substrate comprises a foam, screen, mesh, or honeycomb. The porous substrate can be characterized by its surface area, which can be less than 100 m²/g, e.g., less than 50, 20 or 10 m²/g, and/or by its apparent density, which can be less than 50%.

Example catalyst materials include V₂O₅, Cr₂O₃, MnO₂, Mn₂O₃, Fe₃O₄, Fe₂O₃, FeO, CoO, Co₃O₄, NiO, CuO, ZnO, MoO and NiCo₂O₄. According to embodiments, the catalyst has a crystal structure selected from the group consisting of spinel, pyrochlore and perovskite.

In further embodiments, at least one of the support and the catalyst can be substantially free of carbon, or both the support and the catalyst can be substantially free of carbon.

In further embodiments, the metal oxide catalyst may have appreciable electrical conductivity. In an example embodiment, the electrical conductivity of the metal oxide catalyst is 0.01 S/cm or greater, e.g., 0.1 S/cm or greater.

Such catalyzed structures exhibit superior properties to conventional high surface area carbon-based electrodes. In particular, the disclosed cathode structures exhibit higher capacity and lower charge/discharge hysteresis compared to conventional carbon-based cathodes. Capacities as high as 92000 mA-h/g catalyst have been measured, which is more than 10× the capacity of a conventional catalyzed carbon-based electrode. Such nanowire catalyst structures are effective for the accumulation and decomposition of lithium peroxide in non-aqueous Li-air cells.

The catalyst materials can be formed directly on the support using, for example, precipitation from an aqueous salt solution.

A method of forming a cathode current collector comprises providing a porous conductive support, providing a catalyst precursor, contacting the catalyst precursor with the support to form a mixture, and treating the mixture in order to form nanoscale wires of a metal oxide catalyst over the support.

In embodiments, the contacting can comprise immersing the support in a solution of the catalyst precursor, or exposing the support to a vapor of the catalyst precursor. In further embodiments, the contacting comprises electrophoretic deposition, electroplating, or electrostatic spray deposition.

A pre-treatment such a cleaning pre-treatment of the substrate can be used prior to contacting the substrate with the precursor. The treating can include heating the mixture, for example to a temperature in a range of from 50 to 150° C. Such heating can include, for example, heating under hydrothermal conditions. In certain embodiments, a calcining step can be used to form the catalyst oxide.

### BRIEF DESCRIPTION OF THE DRAWINGS

FIG. 1 is a schematic diagram of a cathode current collector during cycling;

FIG. 2 is (a) an SEM micrograph of Co₃O₄@Ni and (b) a TEM micrograph and SAED patterns for Co₃O₄ nanorods;

FIG. 3 shows SEM images of (a) Co₃O₄@AB, and (b) a pure Co₃O₄ electrode;

FIG. 4 (a) shows first discharge/charge profiles of pure Co₃O₄, Co₃O₄@AB and Co₃O₄@Ni based Li—O₂ cells at 0.1 mA cm⁻², and (b) the variation of specific discharge capacities with cycle number of three different electrodes at 0.1 mA cm⁻²;

FIG. 5 is an SEM micrograph of Co₃O₄@Ni (a) after discharge and (b) after charge, along with c) XRD patterns d) FTIR spectra of the Co₃O₄@Ni before and after discharge;

FIG. 6 shows impedance spectra of Li—O₂ cells based on Co₃O₄@Ni and Co₃O₄@AB at different discharge/charge stages (current density of 0.1 mA cm⁻²) (a) at the beginning of the first discharge, (b) after the first discharge, (c) after the first charge, and (d) after the fifth charge. The inset of FIG. 6(a) shows the equivalent circuit used for the analysis of the impedance plots;

FIG. 7 shows the first discharge/charge profiles of a Co₃O₄@Ni based Li—O₂ cell (a) at a current density of 0.02 mA cm⁻², and (b) at a current density of 0.1, 0.2, and 0.3 mA cm⁻²;

FIG. 8 shows (a) the discharge/charge profiles for Co₃O₄@Ni at 0.02 mAcm⁻², (b) a photograph of the Li surface after cycling, and (c) a photograph of the fresh Li surface after exposure to ambient air for 30 sec;

FIG. 9 is a plot of the first discharge/charge profiles for Co₃O₄@Al based Li—O₂ cells at a current density of 0.02 mA cm⁻²;

FIG. 10 shows the first discharge/charge profiles of a MnO₂@Ni based Li—O₂ cell;

FIG. 11 is an (a) SEM micrograph and (b) EDS scan for MnO₂@Ni;

FIG. 12 shows the first discharge/charge profiles of a Co₃O₄@SS based Li—O₂ cell;

FIG. 13 is an (a) SEM micrograph and (b) XRD scan for Co₃O₄@SS;

FIG. 14 shows plots of Co₃O₄ nanowire length versus various process conditions;

FIGS. 15-17 show SEM micrographs for Co₃O₄@Al for various Al substrates;

FIGS. 18-21 show SEM micrographs for Co₃O₄@C for various carbon foam substrates; and

FIG. 22 shows SEM micrographs for Co₃O₄@SiC.

### DETAILED DESCRIPTION

A cathode current collector for a lithium-air battery comprises a porous conductive support and nanoscale wires of a metal oxide catalyst formed over the support.

In embodiments, an ammonia evaporation-induced growth method was used to form the catalyst material on the substrate. An example catalyst is cobalt oxide, Co₃O₄, which can be directly deposited on metallic nickel foam. This material combination is expressed herein as Co₃O₄@Ni, i.e., as “catalyst”@ “substrate.”

The achieved structure can deliver high capacity at an economical cost.

In an example synthesis, cobalt nitrate and ammonium nitrate were used to form a precursor solution for the synthesis of cobalt oxide. Known quantities of Co(NO₃)₂.6H₂O and NH₄NO₃ were dissolved in H₂O and ammonia. The mixture was stirred for 10 min, and then transferred to a covered glass bottle and heated at 90° C. for 2 h.

The cobalt oxide was formed directly on a metallic Ni foam current collector (Heze Tianyu Technology Development Co., Ltd. China) measuring approximately 14 mm in diameter and 1.1 mm thick. The Ni foam material has a density of approximately 420 g/m².

Initially, the Ni foam was degreased with acetone, etched with HCl, rinsed with deionized water, soaked in NiCl₂ solution, and then rinsed with deionized water.

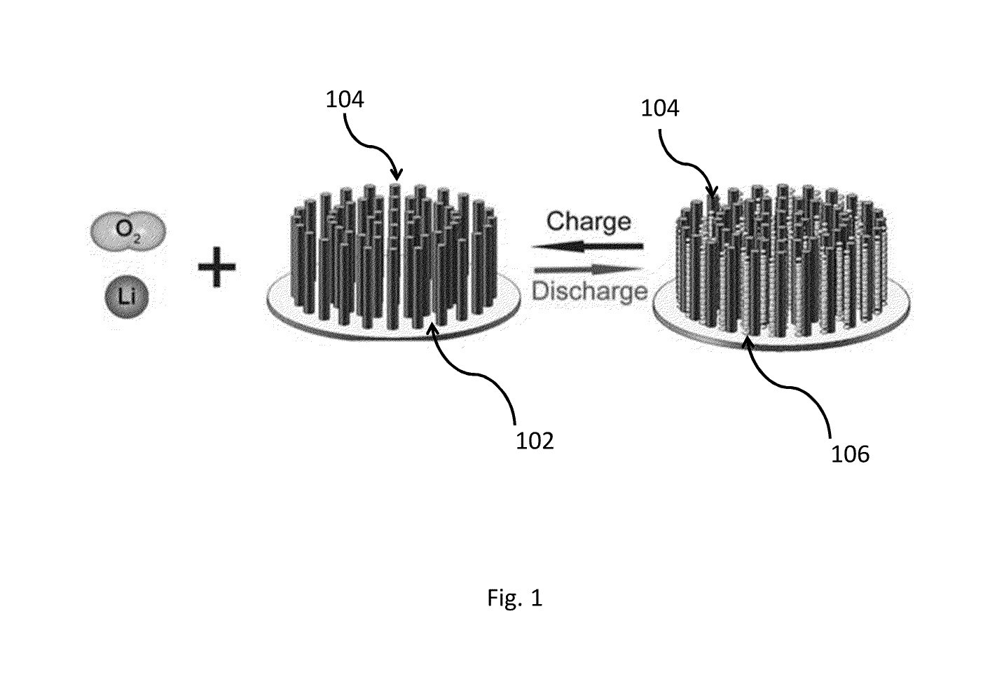

The treated Ni foam was immersed in the precursor solution for 12 h at 90° C. Nanorods of Co₃O₄ were formed on the foam. The thus obtained electrode was thoroughly washed with H₂O, dried at 60° C. for 2 h, and calcined at 300° C. for 2 h in air. With the current procedure, approximately 8 mg of Co₃O₄ nanorods were formed per cm² of Ni foam. The envisaged cycling process of this architecture is illustrated schematically in FIG. 1, which shows catalyst rods 104 formed over current collector 102, and discharge product 10⁶ formed over the catalyst rods 104 after a discharge cycle. Unsupported Co₃O₄ nanorods were obtained via a similar process in the absence of Ni foam.

Morphologies of the synthesized electrodes were observed using a field emission scanning electron microscope (FESEM JSM-6700F) and a transmission electron microscope (TEM JEM-2100F). Structures of the samples were characterized by powder X-ray diffraction, using a Rigaku Ultima diffractometer employing nickel-filtered Cu-Kα radiation. FTIR measurements were carried out on a Fourier Transform Infrared Spectroscope (Tensor 27) in transmission with a KBr pellet. Surface area was determined by BET (Brunauer-Emmett-Teller) measurements using a Tristar 3000 surface area analyzer.

The as-synthesized Co₃O₄@Ni material was pressed into a thickness of 500±20 microns, and then used directly as an air electrode for test Li—O₂ cells.

In addition to the inventive Co₃O₄@Ni electrode material, conventional carbon-supported Co₃O₄@AB electrodes and unsupported Co₃O₄ electrodes were prepared for comparison.

For Co₃O₄@AB comparative samples, cathode structures were formed by casting a ball-milled slurry mixture of the as-prepared Co₃O₄ nanorods (prepare via a process similar to that used to form Co₃O₄@Ni but without the Ni foam), acetylene black carbon (AB) (as a support) and polyvinylidene fluoride (PVDF) (as a binder) with a weight ratio of 19:11:15 onto Ni foams.

For pure Co₃O₄ electrodes, the cathodes were prepared by a similar way for the Co₃O₄@AB with PVDF but without carbon.

The three electrodes were subsequently dried under vacuum at 120° C. for 12 h prior to testing.

Each of the above-mentioned air electrodes have comparable total active material loadings (about 8 mg cm⁻²). For Co₃O₄@Ni electrode, the specific capacity was calculated with the total mass of the catalyst on the current collector; for Co₃O₄@AB, it was calculated with the total mass of the catalyst, binder and carbon on the current collector; and for pure Co₃O₄, with the total mass of the catalyst and binder on current collector. The mass of the current collector Ni foam was excluded in all the three cases.

Electrochemical cells used to investigate Li—O₂ cycling performance were based on a Swagelok cell design, which includes a Li metal anode (14 mm diameter, 0.25 mm thick), an organic electrolyte, a Celgard 2400 separator, and the as-prepared cathode. The electrolyte is 1M battery grade lithium hexafluorophosphate (LiPF₆) in propylene carbonate (PC) (Jangsu Guotai Huarong Chemical Corp., China), which was dried with molecular sieves prior to use.

Individual cells were assembled in a glove box with oxygen and water contents less than 1 ppm. To avoid complications related to H₂O and CO₂ contamination, the cells were tested in 1 atm of flowing pure O₂ rather than in ambient air. Except for the cathode side that was exposed to the flowing O₂, the cells were gas-tight.

Galvanostatic charge and discharge tests were conducted at ambient temperature on a LAND CT2001A battery test system at a current density of 0.02 (or 0.1, 0.2 or 0.3) mA cm⁻² after a 6 h rest period, and with a lower voltage limit of 2.0 V (vs. Li/Li+) and an upper voltage limit of 4.5 V (vs. Li/Li+). So as to examine the charge process, the discharge steps of the cells were designed to be terminated after discharging for 20 days.

For cycling stability studies, cells were discharged and charged at 0.1 mA cm⁻². In order to minimize the side reactions, in the first cycle for the Co₃O₄@Ni electrode, the charge at 0.1 mA cm⁻² was terminated when its capacity was equal to the value in the discharge step. The discharge step of Co₃O₄@Ni at 0.02 mA cm⁻² was designed to be terminated to determine the charging property after a specific capacity of as high as 4000 mAh g⁻¹ was achieved.

Electrochemical impedance spectroscopy of the cells was evaluated using an AC impedance analyzer (Autolab Electrochemical Workstation) over a frequency range of 106 Hz to 10⁻² Hz for the interface investigation of the electrodes in cells during discharge/charge cycles.

In order to further address whether there was substantial influence of water during the low-rate and long-time test over 70 days, and to make the interpretation and comparison of data more justified, the discharge/charge process of Co₃O₄@Ni at 0.02 mA cm⁻² were designed to be terminated every 72 h to further test the cycling results.

Examination of discharged electrodes involved first disassembling the cell in the glove box, rinsing the cathode with dimethyl carbonate, removing the solvent under vacuum, and then introducing the electrode into the airtight SEM, FTIR and XRD tests.

Characterization of Co₃O₄@Ni

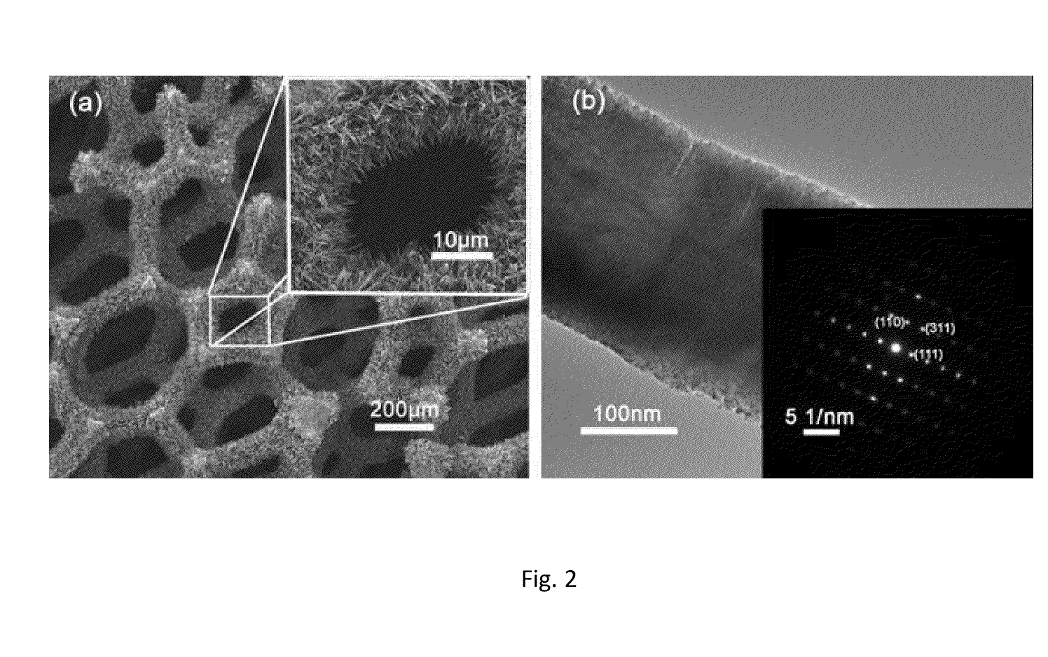

Scanning electron microscope (SEM) images of the Co₃O₄@Ni electrodes are shown in FIG. 2a. The Ni foam is completely and uniformly covered by free-standing parallel Co₃O₄ nanorods, which extend orthogonally from the substrate. The nanorods have a diameter of about 250 nm and a length of up to about 8 mm.

The XRD scans of the Co₃O₄@Ni material show that the Co₃O₄ nanorods are indexed to the spinel Co₃O₄ phase. The selected area electron diffraction (SAED) demonstrates that the Co₃O₄ nanorods include {110} flat planes, {311} side planes and {111} end planes. In other words, the Co₃O₄ nanorod mainly grows along the [111] direction and preferentially exposes the {111} plane.

BET measurement shows that the Co₃O₄ nanorods on Ni foam have a BET surface area of 64 m² g⁻¹.

It will be appreciated that the Ni foam can serve as both the current collector and the substrate for nanorod formation. The Co₃O₄ nanorods and Ni foam substrate structure exhibits a three-dimensional network with micro open cages and zigzag flow channels, which result in an electrode with excellent mass transport property for oxygen diffusion and a large surface area for discharge products to deposit.

Cycling Performance of Co₃O₄@Ni

The electrocatalytic activity of Co₃O₄@Ni for the discharge and charge steps was examined in Li—O₂ cells, where Co₃O₄@Ni electrodes were directly used as the air electrodes. Data for the inventive Co₃O₄@Ni structure was compared with data from conventional carbon-supported Co₃O₄@AB electrodes and unsupported Co₃O₄ nanorods. Specific capacity data was determined using the total active mass in each air electrode.

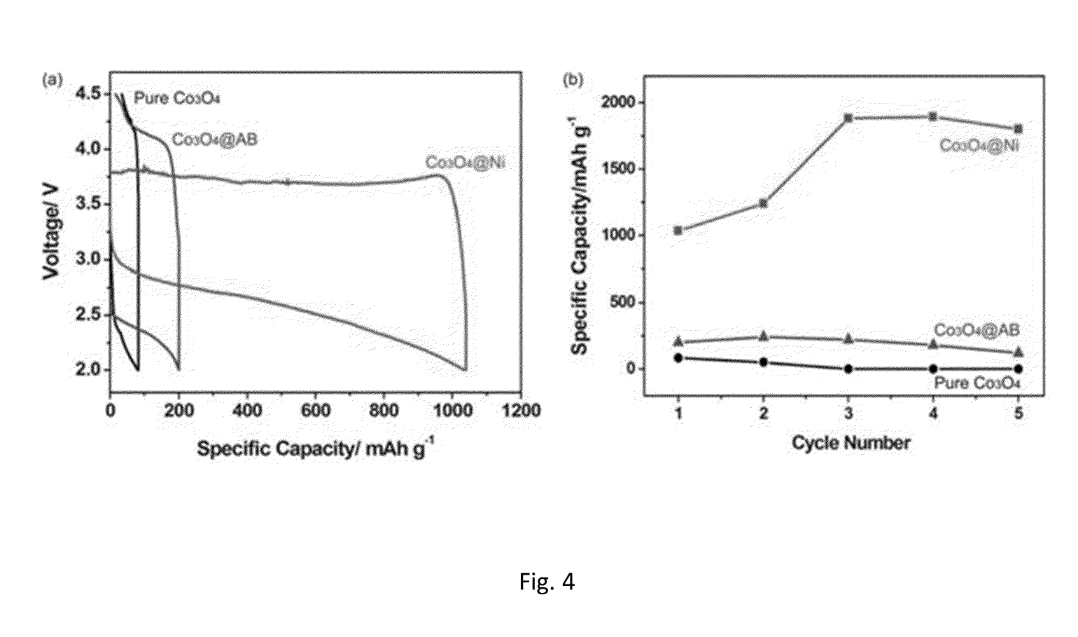

The discharge voltage of Co₃O₄@Ni is consistently higher than that of Co₃O₄@AB by about 600 mV. Referring to FIG. 4a, the charge voltage platform of Co₃O₄@Ni is about 3.65 V (vs. Li/Li+), which is similar to values obtained with PtAu as a catalyst, about 900 mV less than for pure carbon, and about 400 mV less than for Co₃O₄@AB.

In order to verify that the charging voltage is not a result of current collector Ni oxidation or the decomposition of the electrolyte, the cycling of the cell with Ni foam alone as the cathode and the first charge from OCV of the cell with Co₃O₄@Ni as the cathode were tested. The results showed that the side charge reactions associated with Ni oxidation and decomposition of the electrolyte were negligible and mainly above 4.4V, establishing that free-standing Co₃O₄ nanorod catalyzes the reversible oxidation of the discharge products during charge. The almost complete and uniform coverage of Co₃O₄ nanorods on the Ni foam inhibits the side decomposition reaction on Ni based cathodes.

The cycling performances of the three kinds of Co₃O₄-based electrodes at 0.1 mA cm⁻² are showed in FIG. 4b. Charge/discharge of the Co₃O₄@Ni electrode can be stably sustained for several cycles. The specific capacity of the Co₃O₄@Ni electrode is significantly and consistently higher than that of pure Co₃O₄ and Co₃O₄@AB electrodes. After three cycles, Co₃O₄@Ni begins to achieve as high discharge capacity as 1880 mAh g⁻¹ (15.04 mAh cm⁻²). In contrast, pure Co₃O₄ electrode has much smaller values, possibly due to the intrinsically low electric conductivity of the Co₃O₄ and poor electric contact between the catalysts and current collector Ni foam.

The free-standing Co₃O₄@Ni design substantially improves the electric contact between the Co₃O₄ and the Ni foam, which may also be beneficial to suppress the volume expansion of the electrode, which may otherwise lead to the loss of contact between electrode particles and the current collector during subsequent deposition/decomposition of discharge products in conventional carbon-supported electrodes

Characterization of Discharge Products in Co₃O₄@Ni Electrode

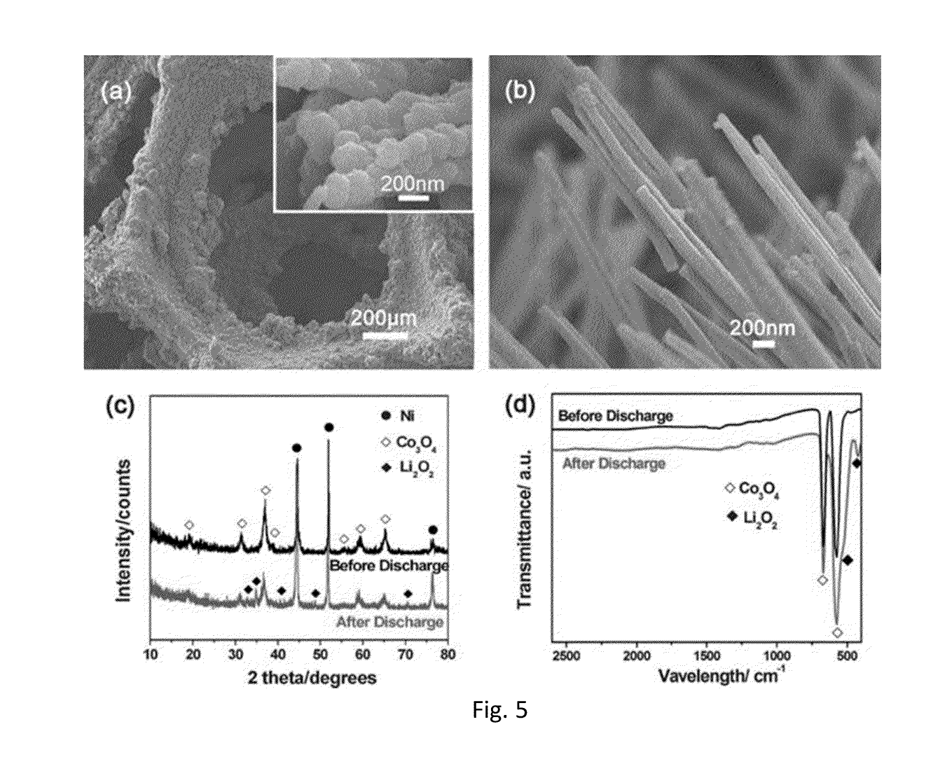

The SEM images of the fully discharged Co₃O₄@Ni electrode are showed in FIG. 5a, which demonstrate that the discharge products actually deposit on the Co₃O₄ surface and in the pores built up by the free-standing CO₃O₄ nanorods and Ni foam. Furthermore, XRD patterns and FTIR spectra of the air electrodes after discharge (FIG. 5c,d) indicate the formation of reversible products Li₂O₂, while neither Li₂O nor LiOH were detected.

The SEM images are also shown for the fully charged Co₃O₄@Ni electrodes (FIG. 5b), which indicate the full decomposition of the discharge products and the high reversibility of the electrodes.

The carbon-free Co₃O₄@Ni based Li—O₂ cells disclosed herein exhibit different discharge and charge voltages from the reported voltage gaps that accompany the decomposition of organic electrolyte in the carbon-supported cathodes. The XRD patterns of the discharged electrodes evaluated herein did demonstrated the reversible formation of Li₂O₂ in lieu of other byproducts.

In order to more concisely identify the discharge products, FTIR data were collected from the discharged Co₃O₄@Ni electrodes without exposure to air (FIG. 5d). The spectra demonstrated no species other than Li₂O₂ (such as Li₂CO₃, C₃H₆(OCO₂Li)₂, HCO₂Li, or CH₃CO₂Li induced by the electrolyte decomposition).

It is speculated that, for the Co₃O₄@Ni electrodes, the influence of electrolyte decomposition is negligible and most of the charge/discharge process corresponds to the reaction of Li+O₂=Li₂O₂, which may be an advantage for Co₃O₄@Ni cathodes in Li—O₂ batteries.

Without wishing to be bound by theory, a primary reason for the formation of Li₂O₂ in Co₃O₄@Ni in based Li—O₂ batteries rather than other discharge species could result from the formation and deposition of discharge products on the active surfaces of the CO₃O₄ nanorods, which in turn catalyze the formation of Li₂O₂.

Improvement in Free-Standing Electrodes

In a conventional carbon-supported air electrode (normally a composite of catalyst/carbon/binder), the practical capacity is influenced by not only the available porosity of the air electrode, but also the occlusion of the catalytic sites by the formation of Li₂O₂. With reduction, extensive nucleation of the products on the catalysts will block the catalytic sites, and with oxidation, the poor contact between the discharge product and the catalyst will inhibit re-chargeability.

Activated carbon in Co₃O₄@AB comparative materials typically does not have inherent electrocatalytic activity, but functions merely as a mechanical support and electronic conduction agent. In such comparative structures, the catalytic function is derived principally from the Co₃O₄ catalysts that are incorporated into the carbon by mechanical mixing.

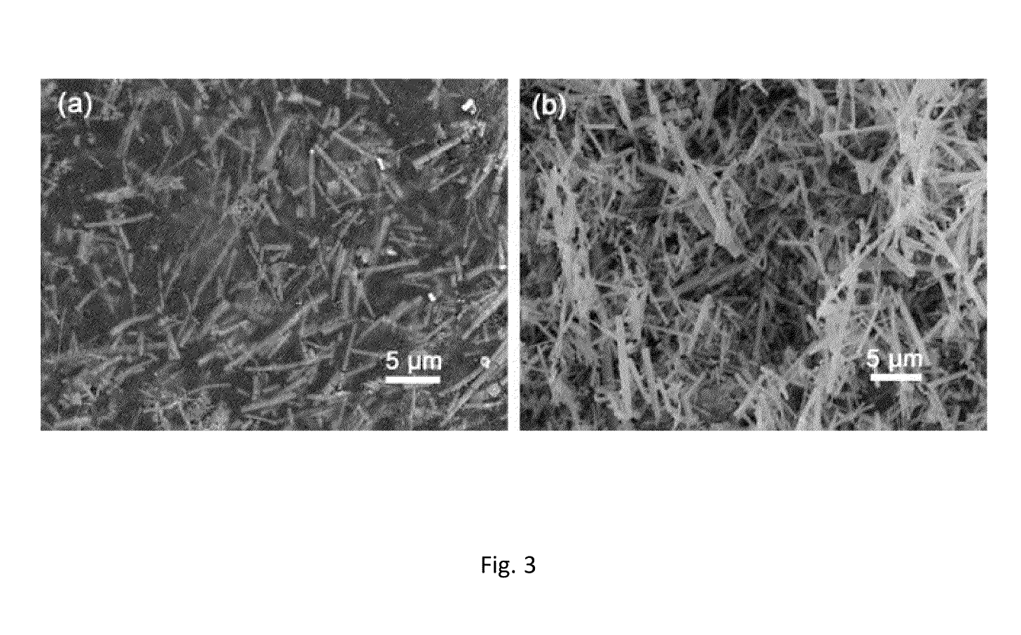

Because the process of mechanical mixing is used to form the conventional carbon-supported catalyst electrodes, non-catalyzed areas, as shown in FIG. 3a, exist within the structure. Upon_discharge, it has been shown that O₂ reduction can occur on these non-catalyzed surfaces. The non-catalyzed discharge reaction in would have a negative influence on the catalyzed discharge process, and eventually lead to a lower discharge voltage. During charging, on the other hand, a lack of intimate contact between the discharge products and the catalytic sites would restrict catalytic reactivity and eventually lead to a high charge voltage and an over-potential condition.

In the freestanding Co₃O₄@Ni electrodes of the present disclosure, there is sufficient void volume for Li₂O₂ storage, and the discharge precipitates form at the active surface of the catalyst. Compared with conventional carbon-supported electrodes that are fabricated by a mechanical mixing method, the active material formed by an in situ chemical deposition method demonstrates better adhesion to the underlying substrate.

Further, while active catalyst sites in a carbon-supported electrode may be obscured because some of the catalyst material is embedded in the pores of the carbon, a relative enhancement of the catalytic activity of Co₃O₄@Ni may be realized due to the unrestricted access of reactant molecules to and from active sites of free-standing Co₃O₄. With Co₃O₄@Ni, each pore can be regarded as a microreactor, and the intrinsic porous structure of the Ni foam can promote good infiltration of liquid electrolyte and O₂ to each such reactor. The foregoing may contribute to the high capacity and the compression of capacity fading in Co₃O₄@Ni during cycling.

Electrochemical Impedance Study of the Electrodes

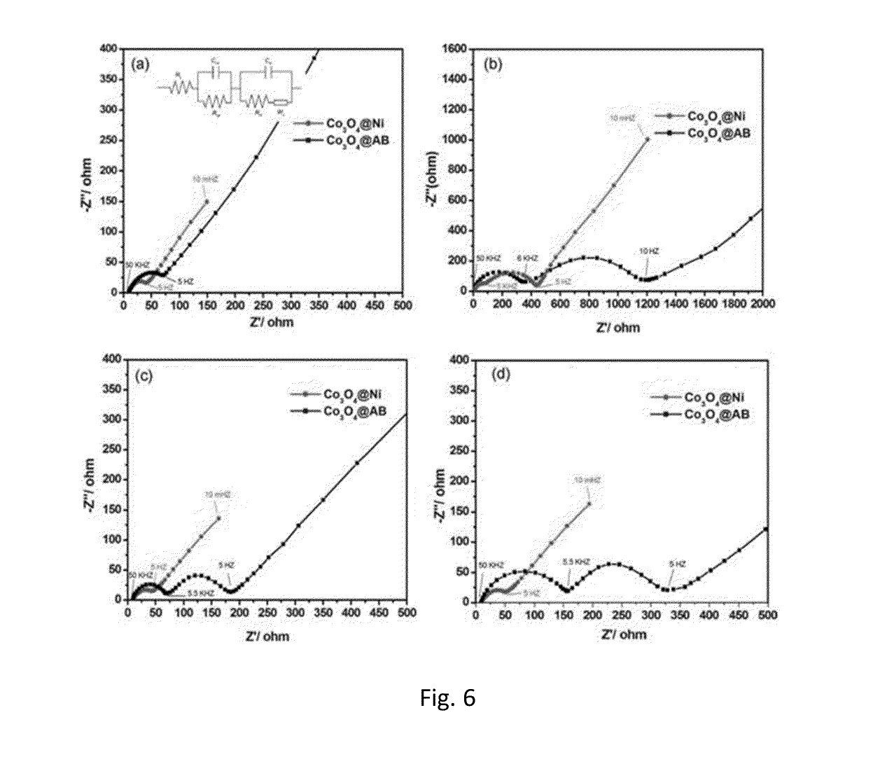

In order to further understand cell performance during cycling, electrochemical impedance spectroscopic analysis (EIS) was conducted on Li—O₂ cells having inventive Co₃O₄@Ni electrodes and comparative Co₃O₄@AB cathodes at different discharge/charge stages. The resulting data is shown in FIG. 6. The equivalent circuit is shown in the inset of FIG. 6a.

FIGS. 6a and 6b show the Nyquist plots for the Li—O₂ cells measured at the beginning and at the end of 1st discharge. After the first deep discharge, large amounts of poorly conductive precipitates are generated at the electrode/electrolyte interface, which results in a significant increase in the interfacial resistance of both cells (Rᵢₙₜ between 50 and 5 kHz, Co₃O₄@AB between 50 KHz and 6 kHz) and the charge-transfer resistance (Rₑₜ between 5 KHz and 5 Hz, Co₃O₄@AB between 6 kHz and 10 Hz).

The R_{ct} of the Co₃O₄@Ni samples is consistently less than that in Co₃O₄@AB samples, indicating the improved reaction kinetics and higher electrocatalytic activity of the Co₃O₄@Ni, which is consistent with the discharge/charge test results.

In order to evaluate the charge efficiency of the electrodes, the EIS of both the Li—O₂ batteries after 1st and 5th deep charge are also tested. These results are shown in the FIGS. 6c and 6d, respectively.

The recovery of the electrode porosity and surface with the decomposition of the discharge products during the charge process could reduce the cell resistance by improving the electronic conductivity of the air electrode. Ideally, a fully charged electrode would obtain the full restoration of the resistance. In Co₃O₄@Ni, the nearly identical cell impedances of 1st and 5th fully charged cells with respect to the original one indicate the decomposition of nearly all the poor electronic conductive products. This conclusion is consistent with the SEM images after full charge as shown in FIG. 5b), full recovery of the electrode surface and the significantly good cycle performance for Li—O₂ batteries.

On the other hand, in the conventional carbon-supported Co₃O₄@AB electrode, the unrecovered and subsequently increasing interfacial resistance (Rᵢₙₜ) and charge transfer resistance (R_{ct}) can be indicative of the incomplete decomposition of the products during the charge process. The sustainable accumulation of the poorly conductive products on the electrode surface impeding lithium-ion and charge transfer within the carbon-supported electrode during subsequent cycling could lead to cell failure in the conventional carbon-supported cell. The subsequent loss of intimate contact among electrode materials induced by the expansion of the electrode may be another important reason for the unrecovered interfacial resistance in Co₃O₄@AB.

The improved electrochemical behavior and charge efficiency observed for the free-standing-type cathode was further substantiated by the EIS analysis, where the Co₃O₄@Ni-based cell is able to fully decompose Li₂O₂, which is a significant advantage in electrode design for efficient, rechargeable Li—O₂ batteries.

Rate Performance of Co₃O₄@Ni

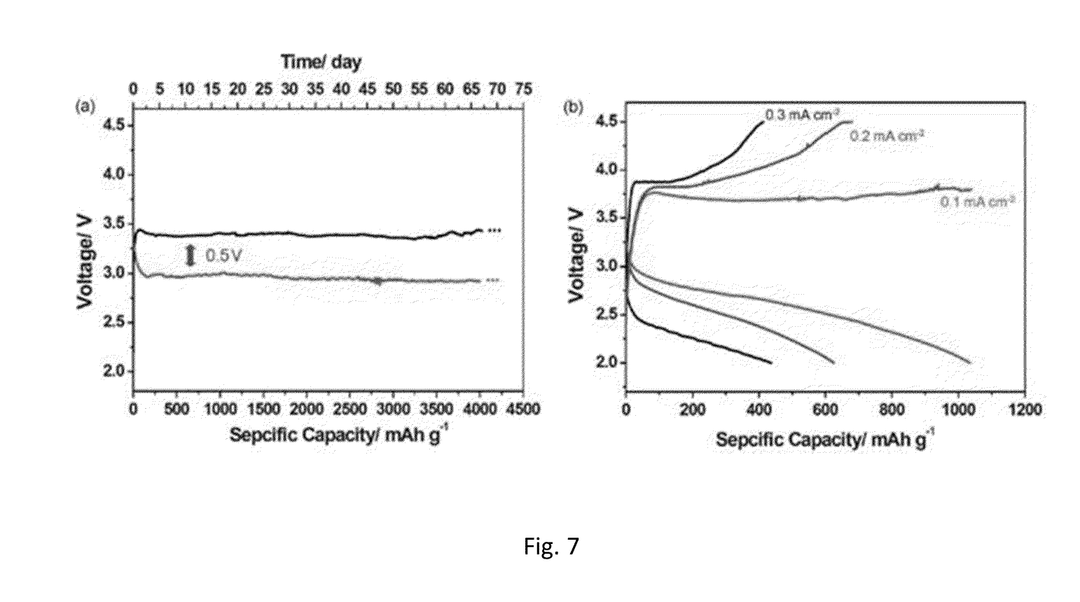

The effect of current density on the discharge and charge voltages of Li—O₂ cells comprising Co₃O₄@Ni electrodes is shown in FIG. 7. At 0.02 mAcm⁻², the tested Li—O₂ cells delivered 3000 mAh g⁻¹_{cathode} at 2.95-2.93 V and continuously reduce O₂ to provide capacity over the testing period of 66.7 days (4000 mAh g⁻¹_{cathode} or 32 mAh cm⁻²), where the voltage of the developed Li—O₂ battery was maintained above 2.91 V.

In addition, the charge voltage platform was also flat within a range of about 3.5-3.4 V. The potential difference between the discharge and charge plateaus of Co₃O₄@Ni is as small as 0.5 V, which is considerably lower than that of PtAu (−0.8 V at 0.02 mA cm⁻²).

With the increasing current densities, a decrease in the discharge voltage and an increase in the charge voltage was observed. At a higher current density, oxygen diffusion is limited, which becomes the rate limiting variable. The full catalytic activity can be realized at lower current densities where the electrochemical polarization determines the nature of the electrode and the catalyst plays the major role.

The reaction voltages at 0.02 mA cm⁻² demonstrate that the Co₃O₄@Ni electrode is a good candidate as an air electrode for a Li—O₂ battery. The ultimate discharge and charge performance may be limited by other factors, such as the volatilization of the electrolyte and the cell configuration, rather than by the electrode itself. It is expected that for the as-prepared air-electrode, cell performance at the higher current densities can be further enhanced by optimizing the electrolyte composition, and the air-liquid-solid three-phase interface.

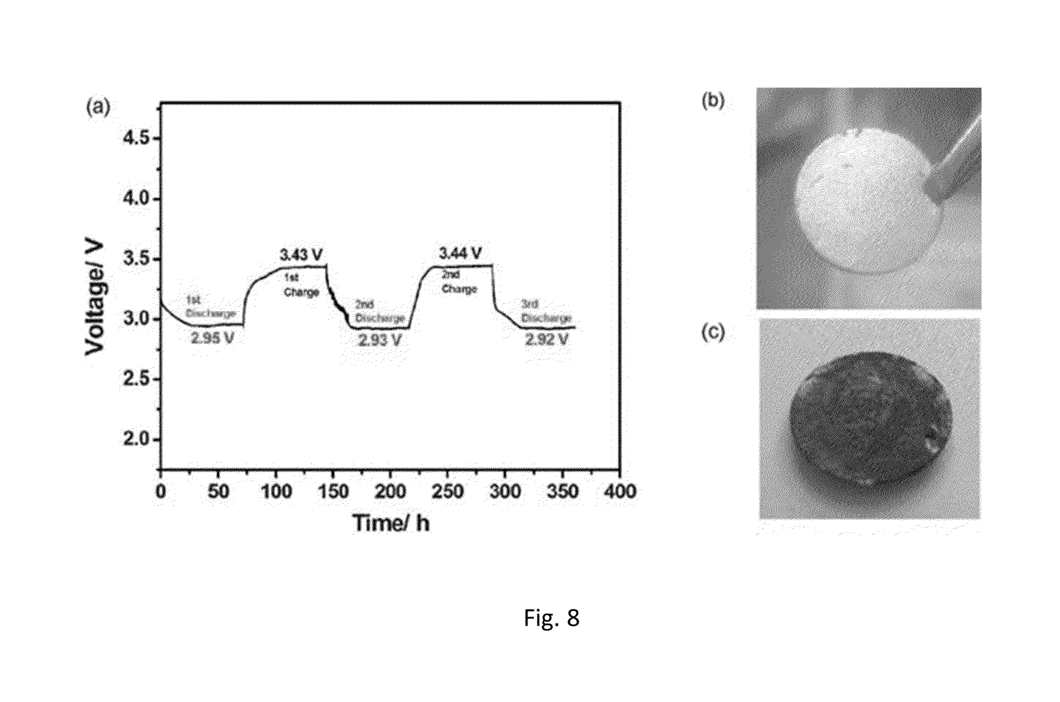

It is interesting to note that the discharge voltage of the Co₃O₄@Ni based Li—O₂ cell is as high as that of an aqueous Li-air battery (approximately 3.1 V). In order to examine the possibility of water contamination, which would give rise to a high cell voltage, the discharge/charge examination of the Co₃O₄@Ni at 0.02 mA cm⁻² was repeated where the discharge and charge were terminated at 72 h in order to obtain additional cycling results, as shown in FIG. 8a. The data indicate that the discharge/charge process of Co₃O₄@Ni at 0.02 mA cm⁻² was highly reversible with similar discharge/charge potential platforms for each cycle, which demonstrates the stability of the Li surface. Otherwise, a non-active film on the Li surface induced by impurity water contamination would prevent further Li deposition/dissolution. At the end of the 3rd discharge, the cell was dissembled and revealed a Li electrode as pristine as the primitive surface (FIG. 8b), further demonstrating no contamination of water in the cell. A Li surface that is exposed to humid atmosphere would darken quickly as shown in FIG. 8c. Moreover, XRD analysis of the discharged air electrode after the 3rd discharge in FIG. 8a also certified pure Li₂O₂ and no LiOH phase.

As disclosed above, the cathode structure can be formed by immersing a metal or conductive ceramic substrate into a precursor solution for the desired catalyst. Optionally, the substrate can be cleaned prior to immersion. By controlling the interaction parameters between the substrate and the precursor solution, which include time and temperature, nanoscale catalyst structures can be formed directly on exposed surfaces of the substrate. Further, the as-formed materials from the precursor solution may be hydroxides, which can be calcined to form nanocatalyst metal oxides that are intimately bonded to the support.

The following examples further illustrate example embodiments of the disclosure.

### Example 1

### Co₃O₄ Nanowires on Al Foam

Co(NO₃)₂ (10 mmol) and NH₄NO₃ (5 mmol) were dissolved in a mixture of 35 ml H₂O and 15 ml ammonia (30 wt. %) and magnetically stirred for 10 min in air at room temperature to form a precursor solution. The precursor solution was transferred to a covered glass battle and heated in an oven at 90° C. for 2 h.

An aluminum foam substrate (Duocel, 40 pores per inch or PPI) was degreased with acetone, etched with 6 M HCl for 20 min, rinsed with deionized water, soaked in 0.1 mmol/l AlCl₃ for 4 h, and then rinsed with water. The treated Al foam was immersed in the precursor solution for 12 h at 90° C. during which time nanowires were formed on surfaces of the aluminum. The obtained structure was thoroughly washed with H₂O, dried at 60° C. for 2 h, and calcined in air at 300° C. for 2 h to form a Co₃O₄@Al cathode structure.

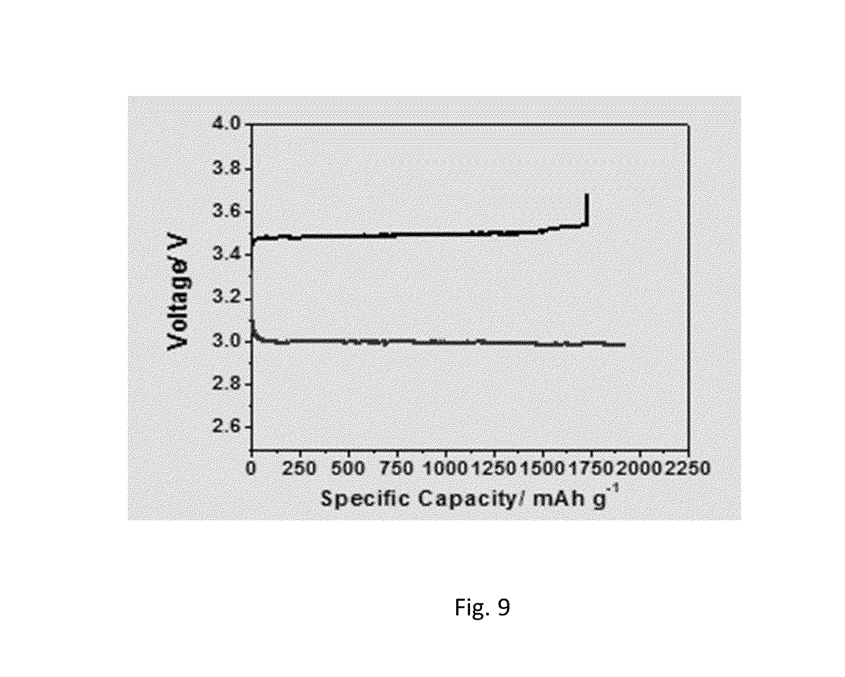

The Co₃O₄@Al cathode was tested at a current density of 0.02 mA/cm². A plot of the first discharge/charge profiles for Co₃O₄@Al based LiO₂ test cells are shown in FIG. 9. The discharge voltage of the Co₃O₄@Al electrode was at about 3 V (vs. Li/Li⁺). The charge voltage platform of Co₃O₄@Al was about 3.5 V (vs. Li/Li⁺). A capacity of at least 1920 mAh/g Co₃O₄ was measured, which corresponds to 69.56 mA-h/g total electrode mass.

### Example 2

### MnO₂ Nanowires on Ni Foam

Ni foam substrates (Heze Tianyu Technology Development Co., Ltd. China) having a diameter and thickness of 14 mm and 1.1 mm, respectively, were degreased with acetone, etched with 6 M HCl for 20 min, rinsed with deionized water, soaked in 0.1 mmol/l NiCl₂ for 4 h, and then rinsed with water. A solution of 0.1 M Na₂SO₄ and 0.1 M Mn(CH₃COO)₂ was used as an precursor solution.

The pretreated Ni foam was immersed in the precursor solution as a working electrode. A saturated calomel electrode (SCE) was used as the reference electrode and a platinum sheet with high surface area was used as the counter electrode. Nanowires of MnO₂ were formed on the nickel foam using the potentiostatic (PS) method under 0.6V for 15 min. The resulting MnO₂@Ni electrodes were washed with H₂O and dried at 60° C. for 12 h in vacuum.

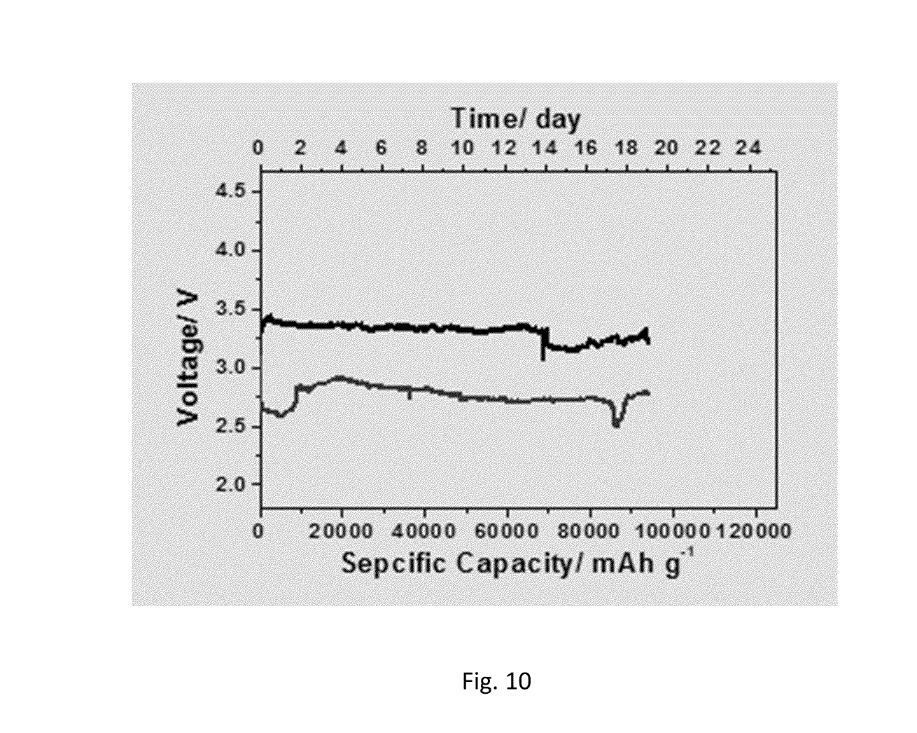

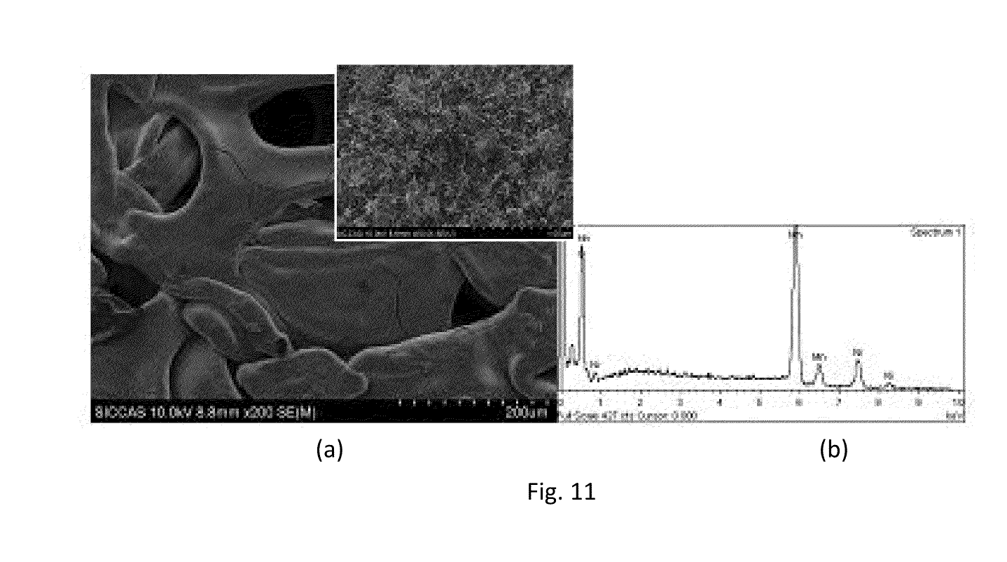

The MnO₂@Ni cathode was tested at a current density of 0.02 mA/cm². Referring to FIG. 10, the discharge voltage of the MnO₂@Ni electrode was about 2.85 V (vs. Li/Li⁺) and the charge voltage platform of MnO₂@Ni was about 3.45 V (vs. Li/Li⁺). A maximum capacity of at least 92000 mAb/g MnO₂ was obtained, which corresponds to 319.46 mAh/g total electrode mass. FIGS. 11(a) and 11(b) shows SEM images and EDS data, respectively, for MnO₂@Ni.

### Example 3

### Co₃O₄ Nanowires on SS Mesh

A precursor solution comprising Co(NO₃)₂ (10 mmol) and NH₄NO₃ (5 mmol) was prepared as in Example 1, and then transferred to a covered Petri dish and heated in an oven at 90° C. for 2 h.

A stainless steel mesh substrate (304 stainless steel) was degreased with acetone, etched with 6 M HCl for 20 min, rinsed with deionized water, soaked in 0.1 mmol/l FeCl₃ for 4 h, and then rinsed with water. The treated SS mesh was immersed in the precursor solution for 12 h at 90° C. during which time nanowires were formed on surfaces of the stainless steel. The obtained structure was washed with H₂O, dried at 60° C. for 2 h, and calcined in air at 300° C. for 2 h to form a Co₃O₄@SS cathode structure.

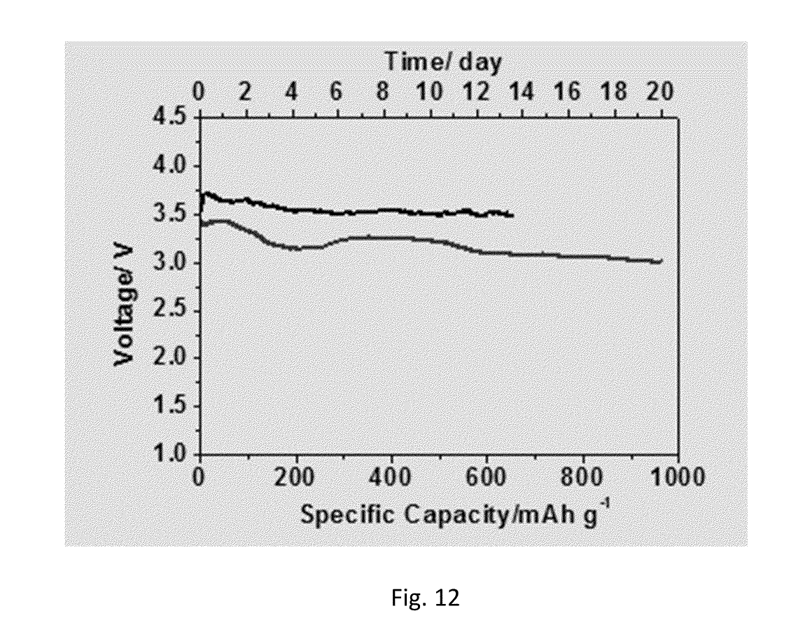

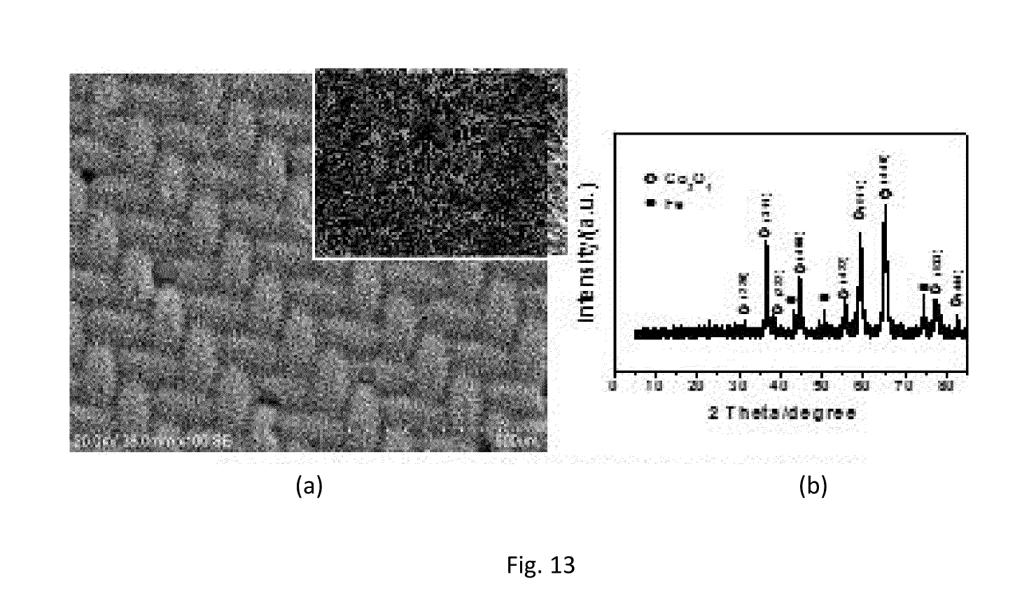

The Co₃O₄@SS cathode was tested at a current density of 0.02 mA/cm². Referring to FIG. 12, the discharge voltage of the Co₃O₄@SS electrode was at about 3 V (vs. Li/Li⁺). The charge voltage platform of Co₃O₄@Al was about 3.7 V (vs. Li/Li⁺). A maximum capacity of at least 960 mAh/g Co₃O₄ was obtained, which corresponds to 266.67 mA-b/g total electrode mass. FIGS. 13(a) and 13(b) shows SEM images and XRD data, respectively, for Co₃O₄@SS.

### Example 4

### Process Condition Study of Co₃O₄ Nanowire Formation on Ni Foam and Fe Mesh

The formation of Co₃O₄ nanowires was evaluated in terms of precursor solution concentration (0.1, 0.15, 0.2, 0.3 M of Co(NO₃)₂) and heating temperature (60, 85, 90, 95, 100, 110, 115, 120° C.).

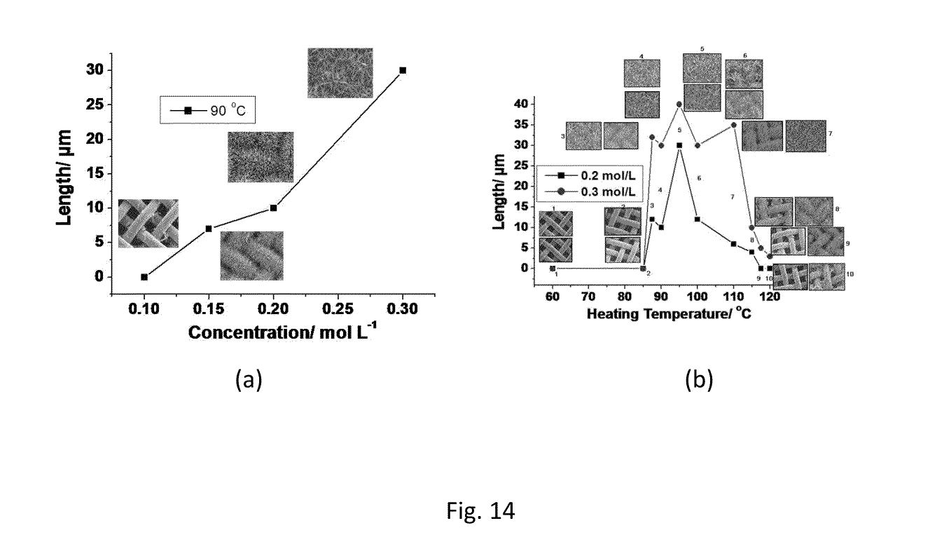

From 0.1 mol/L, the Co₃O₄ nanowires grow longer with the increase of concentration, while the diameter is unchanged. At 0.1 mol/L, Co₃O₄ nanowires grown could be obtained at the temperature of 87.5° C.; at 0.2 mol/L, from 87.5 to 115° C.; and at 0.3 mol/L from 87.5 to 120° C. As the temperature increases, the length of the nanowire first increases and then decreases. Nanowire length versus precursor concentration and length versus heating temperature data is shown in FIG. 14 (a) and (b), respectively.

### Example 5

### Co₃O₄ Nanowires on Aluminum Foams

A precursor solution comprising Co(NO₃)₂ (10 mmol) and NH₄NO₃ (5 mmol) was prepared as in Example 1, and then transferred to a covered glass bottle and heated in an oven at 90° C. for 2 h.

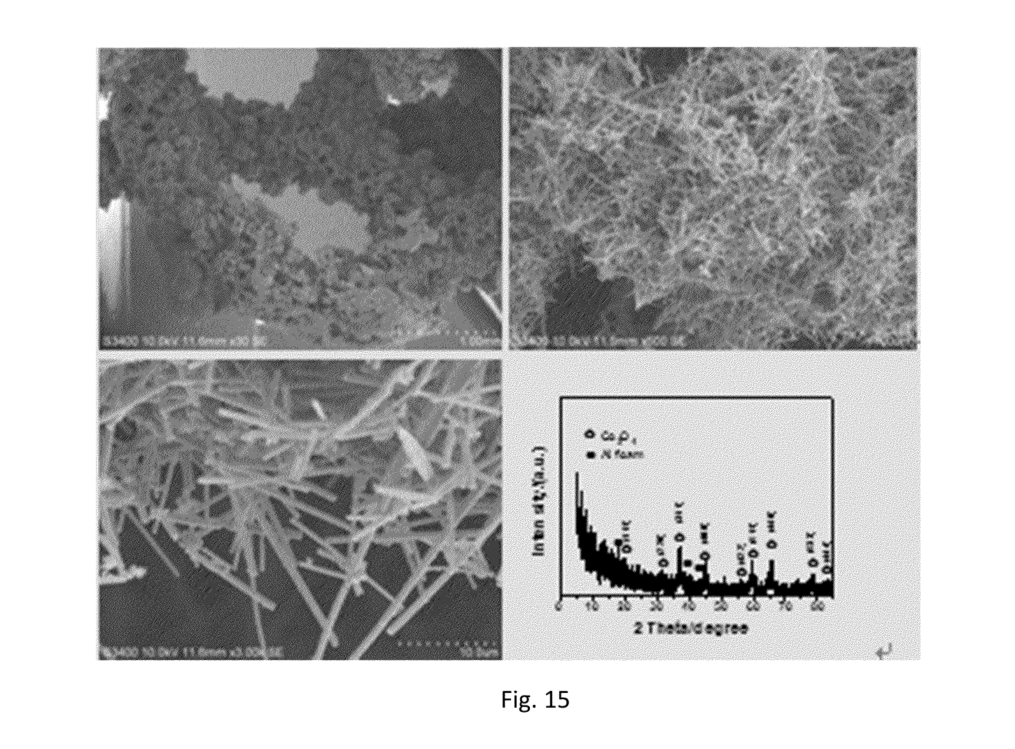

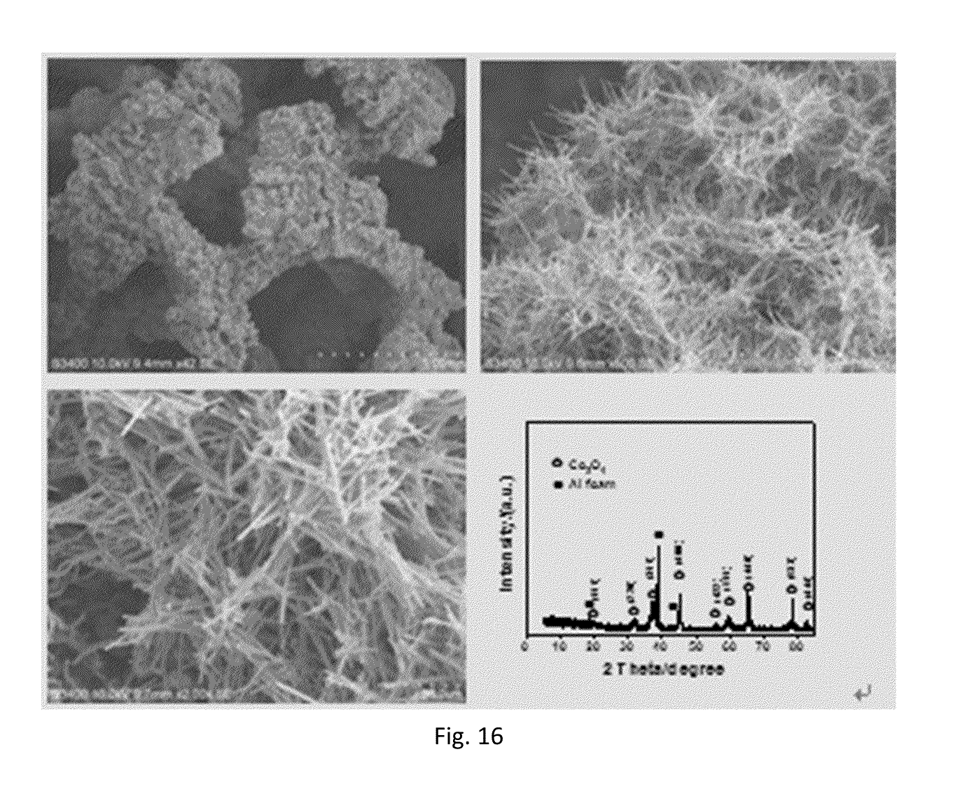

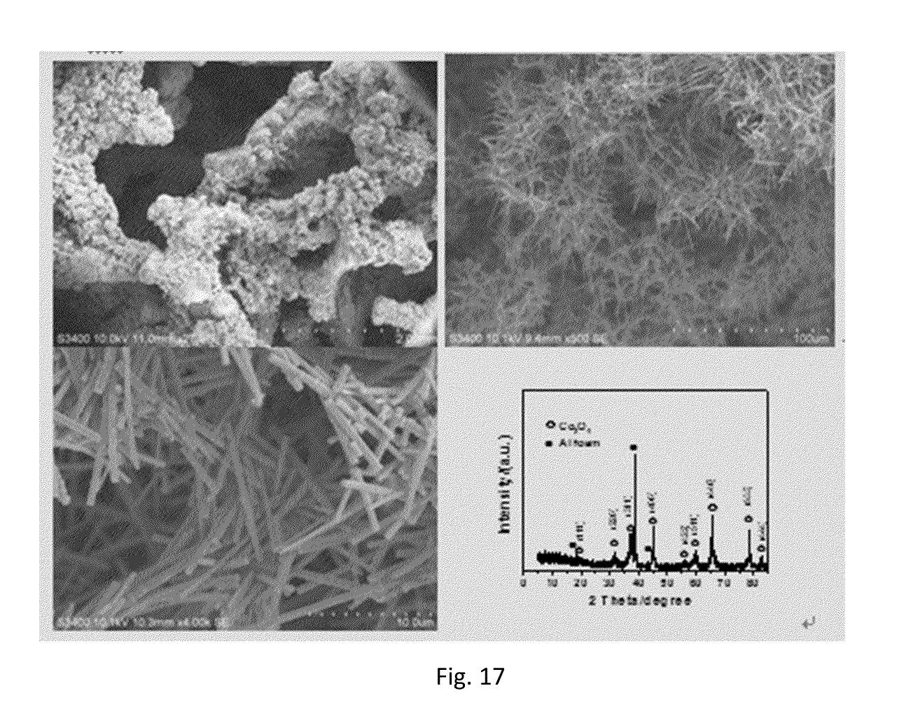

Aluminum foam substrates (Duocel, 10, 20 and 40 PPI) were degreased with acetone, etched with 6 M HCl for 20 min, rinsed with deionized water, soaked in 0.1 mmol/l AlCl₃ for 4 h, and then rinsed with water. Nanowires were formed on the treated aluminum substrates by immersing the substrates in the precursor solution for 12 h at 90° C. The resulting structures were washed with H₂O, dried at 60° C. for 2 h, and calcined in air at 300° C. for 2 h. SEM micrographs showing the evolution of Co₃O₄@Al for the different pore density substrates (10, 20 and 40 pores per inch) are shown in FIGS. 15-17.

### Example 6

### Co₃O₄ Nanowires on Carbon Foams

A precursor solution comprising Co(NO₃)₂ (10 mmol) and NH₄NO₃ (5 mmol) was prepared as in Example 1, and then transferred to a covered glass bottle and heated in an oven at 90° C. for 2 h.

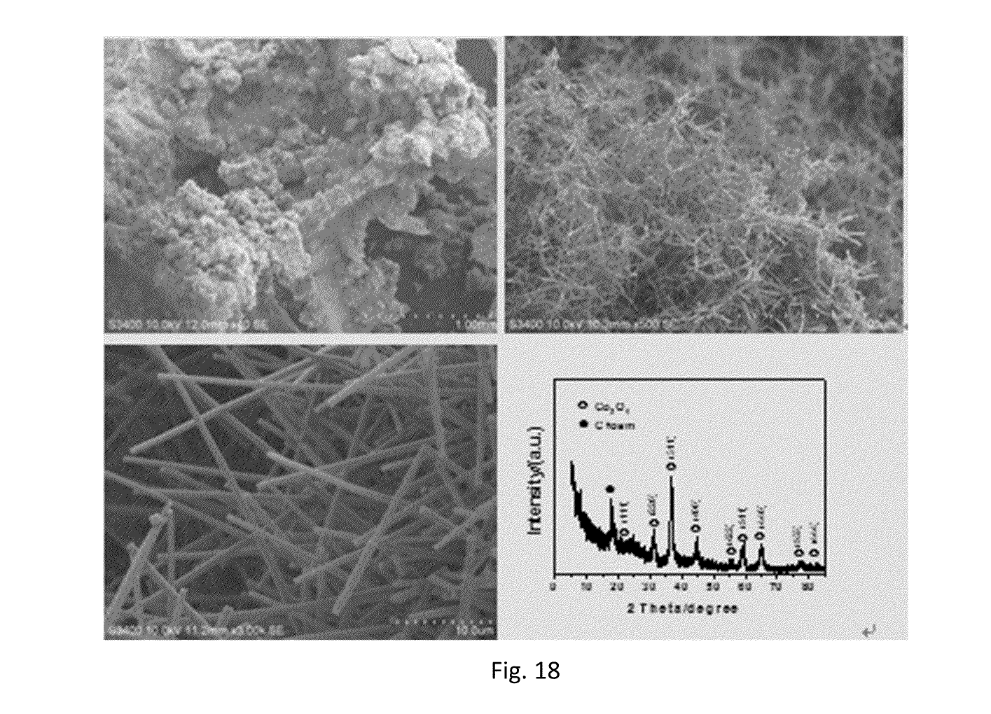

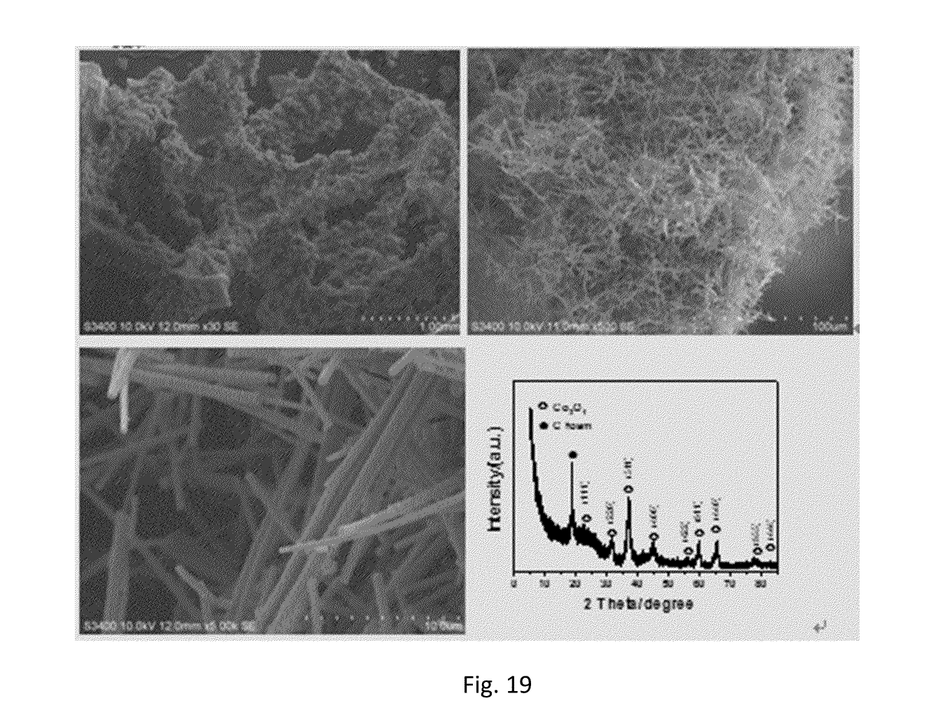

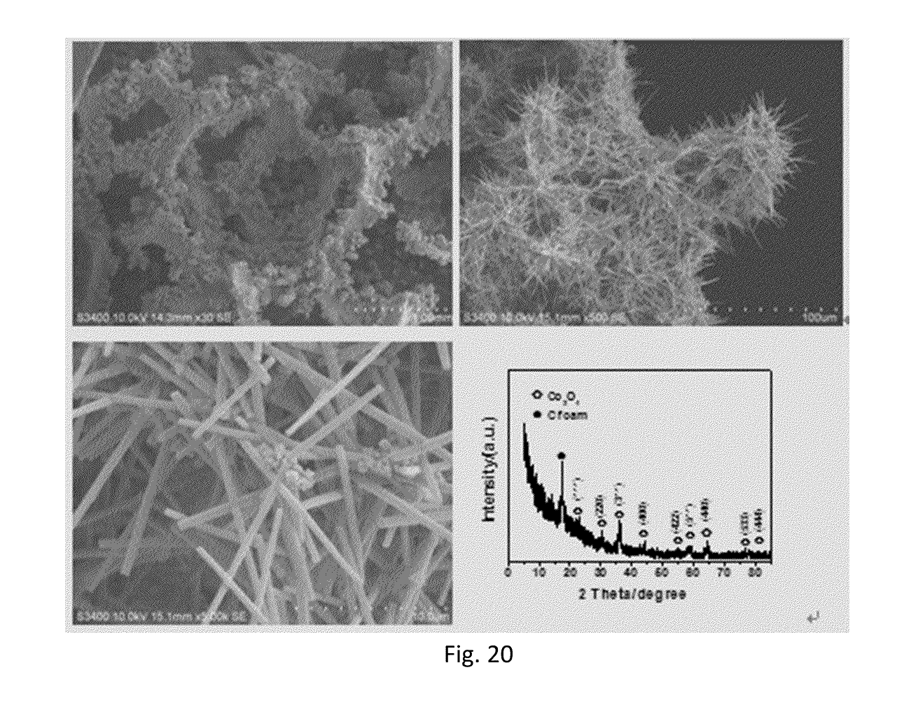

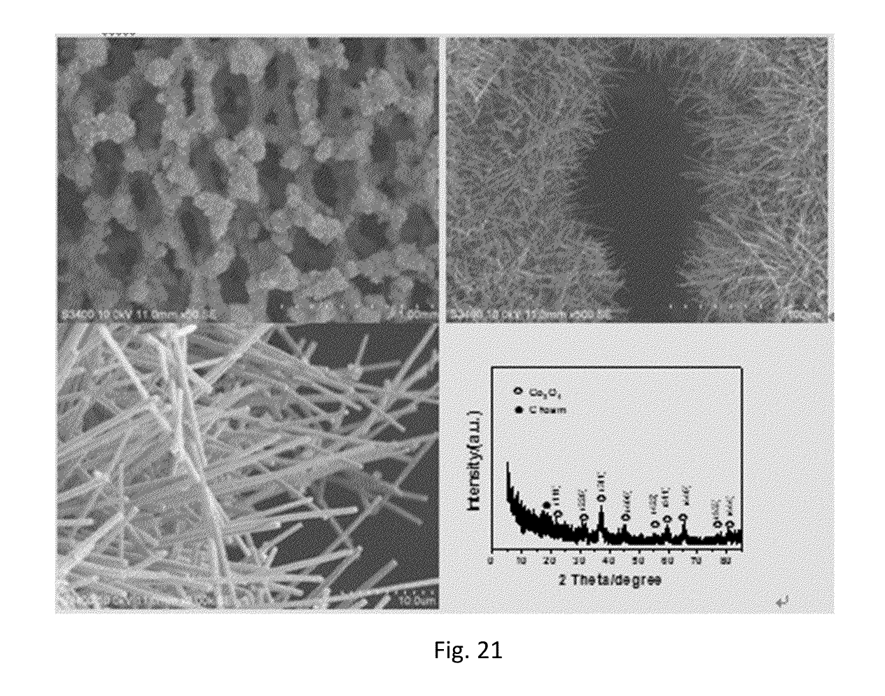

Carbon foam substrates (Duocel, 10, 20, 45 and 100 PPI) were rinsed with deionized water. The treated carbon foams were immersed in the precursor solution for 12 h at 90° C. to form cobalt oxide nanowires. The resulting structures were washed with H₂O, dried at 60° C. for 2 h, and calcined in air at 300° C. for 2 h. SEM micrographs showing the evolution of Co₃O₄@C for the different pore density substrates (10, 20, 45 and 100 pores per inch) are shown in FIGS. 18-21.

### Example 7

### Co₃O₄ Nanowires on Silicon Carbide Foams

A precursor solution comprising Co(NO₃)₂ (10 mmol) and NH₄NO₃ (5 mmol) was prepared as in Example 1, and then transferred to a covered glass bottle and heated in an oven at 90° C. for 2 h.

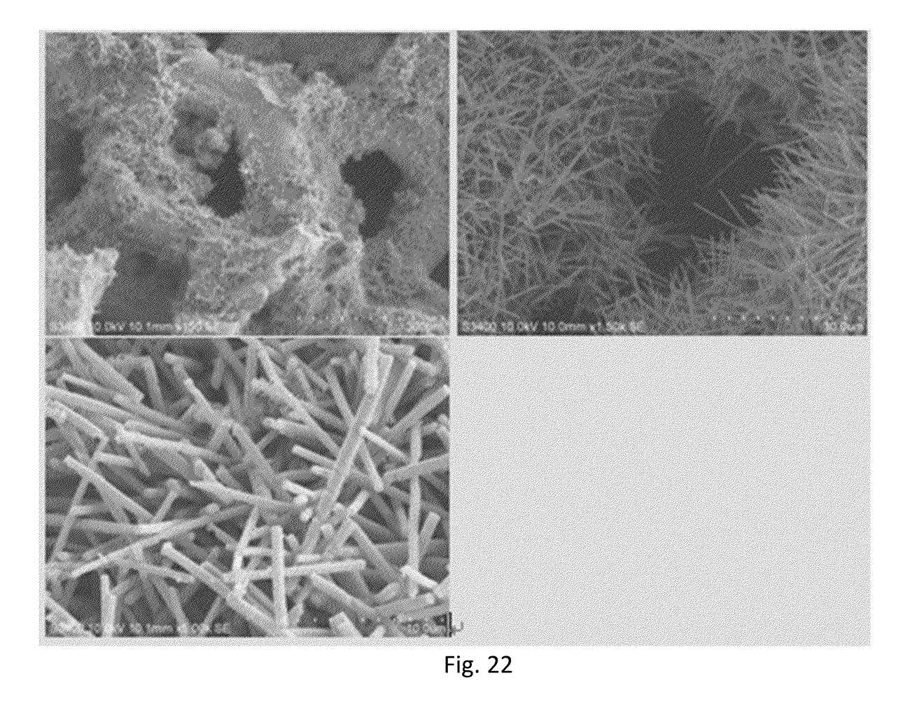

SiC foam substrates (Duocel, 100 PPI) were rinsed with deionized water. The treated SiC foam was immersed in the precursor solution for 12 h at 90° C. to form cobalt oxide nanowires. The result structures were washed with H₂O, dried at 60° C. for 2 h, and calcined in air at 300° C. for 2 h. SEM micrographs showing Co₃O₄@SiC are shown in FIG. 22.

### Example 8

### NiCo₂O₄ on SS Mesh

A precursor solution comprising nickel nitrate and cobalt nitrate in a 1:2 mole ratio was prepared similarly to Example 1. As with example 3, a stainless steel mesh substrate was immersed in the precursor solution for 12 hours at 90° C., removed, washed with water, dried and calcined at 300° C. for 2 hours to make a NiCo₂O₄@SS cathode structure.

Formation of NiCo₂O₄ phase was confirmed by XRD. The NiCo₂O₄@SS cathode was tested at a current density 0.02 mA/cm². The discharge voltage was 3.2 V and the charge voltage was 3.25 V. A maximum capacity greater than 1200 mAb/g NiCo₂O₄ was measured. The very low over-potential, with a voltage gap of only ˜0.05 V, is attributed to the higher electronic conductivity of NiCo₂O₄ (˜0.28 S/cm) compared to Co₃O₄ (˜3×10⁻⁵ S/cm).

The synthesis conditions and the corresponding electrical data for example 1-3 and 8 are summarized in Table 1. The discharge voltage (V_{d}) and the charge voltage (V_{c}) are shown for each example. Also tabulated are the specific capacities (both with and without an accumulator) as well as the respective energy densities (with and without an accumulator).

TABLE 1
Specific Capacity and Energy Density

| | | | | | Specific | Specific | | Energy |
|---|---|---|---|---|---|---|---|---|
| | | Active | | | capacity (no | capacity | Energy density | density |
| | | material mass | V_{d} | V_{c} | acc) | (acc) | (no acc) | (acc) |
| Ex. | Electrode | [mg/cm²] | [V] | [V] | [mAh/g] | [mAh/g] | [Wh/kg] | [Wh/kg] |
| 1 | Co₃O₄@Al | 5 (Co₃O₄) + | 3 V | 3.5 | >1920 | >69.56 | >1920 × | >69.56 × |
| | | 133 (Al) | | | | | 3 V = | 3 V = |
| | | | | | | | 5760 | 208.70 |
| 2 | MnO₂@Ni | 0.1 (Co₃O₄) + | 2.85 | 3.45 | >92000 | >139.18 | >92000 × | >139.18 × |
| | | 66 (Ni) | | | | | 2.85 V = | 2.85 V = |
| | | | | | | | 262200 | 396.66 |
| 3 | Co₃O₄@SS | 10 (Co₃O₄) + | 3 V | 3.7 | >960 | >266.67 | >960 × | >263.89 × 3 V = |
| | | 26 (SS) | | | | | 3 V = | 800.1 |
| | | | | | | | 2880 | |
| 8 | NiCo₂O₄@SS | | 3.2 | 3.25 | >1200 | | | |

### Comparative Example 1

### Co₃O₄ Nanowires Attempted on Carbon Powder

A precursor solution comprising Co(NO₃)₂ (10 mmol) and NH₄NO₃ (5 mmol) was prepared as in Example 1, and then transferred to a covered Petri dish and heated in an oven at 90° C. for 2 h.

Activated carbon (AC) powder was degreased with acetone, and then rinsed with water. The treated AC was immersed in the precursor solution for 12 h at 90° C., and then washed with H₂O and dried for 2 h at 60° C. No Co₃O₄ nanowires formed on the activated carbon.

As used herein, the singular forms “a,” “an” and “the” include plural referents unless the context clearly dictates otherwise. Thus, for example, reference to a “oxide” includes examples having two or more such “oxides” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It is also noted that recitations herein refer to a component of the present invention being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

It will be apparent to those skilled in the art that various modifications and variations can be made to the present invention without departing from the spirit and scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A cathode current collector for a lithium-air battery comprising a porous conductive support and nanoscale wires of a metal oxide catalyst formed over the support.

2. The cathode current collector according to claim 1, wherein the nanoscale wires physically contact the support.

3. The cathode current collector according to claim 1, wherein the nanoscale wires extend substantially orthogonal to a surface of the support.

4. The cathode current collector according to claim 1, wherein the nanoscale wires extend from a surface of the support at an angle of from 30° to 90°.

5. The cathode current collector according to claim 1, wherein the nanoscale wires have an average diameter in a range of 5 to 1000 nm.

6. The cathode current collector according to claim 1, wherein the nanoscale wires have an average length 1 to 1000 microns.

7. The cathode current collector according to claim 1, wherein the nanoscale wires have an aspect ratio (l/d) of at least 5.

8. The cathode current collector according to claim 1, wherein the porous substrate comprises an elemental metal, carbon, a compound of a transition metal element or a conductive ceramic.

9. The cathode current collector according to claim 1, wherein the porous substrate comprises Fe, Ni, Ti, Al, Cu, carbon, stainless steel, steel wool, SiC or Si₃N₄.

10. The cathode current collector according to claim 1, wherein the porous substrate comprises a foam, screen, mesh, or honeycomb.

11. The cathode current collector according to claim 1, wherein the porous substrate has a surface area of less than 100 m²/g.

12. The cathode current collector according to claim 1, wherein the porous substrate has an apparent density of less than 50%.

13. The cathode current collector according to claim 1, wherein the catalyst is selected from the group consisting of V₂O₅, Cr₂O₃, MnO₂, Mn₂O₃, Fe₃O₄, Fe₂O₃, FeO, CoO, Co₃O₄, NiO, CuO, ZnO, MoO and NiCo₂O₄.

14. The cathode current collector according to claim 1, wherein the catalyst has a crystal structure selected from the group consisting of spinel, pyrochlore and perovskite.

15. The cathode current collector according to claim 1, wherein at least one of the support and the catalyst is substantially free of carbon.

16. The cathode current collector according to claim 1, wherein the support and the catalyst are substantially free of carbon.

17. A lithium-air battery comprising the cathode current collector according to claim 1.

18. A method of forming a cathode current collector comprising a porous conductive support and nanoscale wires of an oxide catalyst formed over the support, said method comprising:
providing a porous conductive support;
providing a catalyst precursor;
contacting the catalyst precursor with the support to form a mixture; and
treating the mixture in order to form nanoscale wires of a metal oxide catalyst over the support.

19. The method according to claim 18, wherein the contacting comprises immersing the support in a solution of the catalyst precursor.

20. The method according to claim 18, wherein the contacting comprises exposing the support to a vapor of the catalyst precursor.

21. The method according to claim 18, wherein contacting comprises electrophoretic deposition, electroplating, or electrostatic spray deposition.

22. The method according to claim 18, further comprising pre-treating the substrate prior to the contacting.

23. The method according to claim 18, wherein the treating comprises heating the mixture.

24. The method according to claim 18, wherein the treating comprises heating the mixture to a temperature in a range of from 50 to 150° C.

25. The method according to claim 24, wherein the heating comprises a hydrothermal reaction.

26. The method according to claim 18, wherein the treating comprises calcining.

27. The cathode current collector according to claim 1, wherein the metal oxide catalyst has an electrical conductivity of at least 0.01 S/cm.

28. The cathode current collector according to claim 1, wherein the metal oxide catalyst has an electrical conductivity of at least 0.1 S/cm.
